(19) United States
(12) Patent Application Publication
(10) Pub. No.: US 2009/0263300 A1
(43) Pub. Date: Oct. 22, 2009

(54) Stabilized Iridium and Ruthenium Catalysts

(76) Inventor: Xiaolin D. Yang, Edison, NJ (US)

Correspondence Address: BASF CATALYSTS LLC, 100 CAMPUS DRIVE, FLORHAM PARK, NJ, 07932, US

(21) Appl. No.: 12/103,850

(22) Filed: Apr. 16, 2008

(51) Int. Cl. B01J 23/46; B32B 3/12; B01D 53/56; B01D 53/72; B01D 53/62

(52) U.S. Cl. 423/213.5; 502/328; 428/116; 427/372.2; 423/245.3; 423/239.1

(57) ABSTRACT

Provided herein is a non-single phase perovskite-type bulk material comprising one or more of Ru and Ir. In one embodiment, the surface region of the material is enriched with one or more of Ru and Ir relative to the bulk material. Also provided are methods for preparing the non-single phase, surface enriched perovskite-type material, catalytic articles comprising the non-single phase, surface enriched perovskite-type material and methods for their preparation, and methods for treating exhaust emissions using the non-single phase, surface enriched perovskite-type material.

### FIELD OF THE INVENTION

Embodiments of the present invention relate generally to iridium- and ruthenium-containing composite metal oxide catalysts that can be used at high temperatures. More particularly, embodiments of the present invention relate to thermally stabilized iridium- and ruthenium-containing catalysts having utility in reduction of NOx from exhaust emissions, such as automobile exhaust emissions.

### BACKGROUND

NOx is one of the major pollutants emitted from a number of sources such as utility power plants, petroleum refinery units, and especially automobiles. Catalytic reduction of NOx is a key solution to meet the stringent regulations. Supported rhodium (Rh) and platinum (Pt) are the most commonly used catalysts for catalytic NOx reduction. A drawback of Pt-based catalysts, however, is that the majority of NOx is reduced by Pt-based catalysts to N₂O, which itself is a greenhouse gas, especially under lean burn conditions. Although Rh is a more effective precious metal than Pt for selective catalytic reduction (SCR) of NOx to N₂, its high price has limited its usefulness in commercial applications.

Ruthenium (Ru) and iridium (Ir) are known for their excellent NOx reduction activity. Among all of the platinum group metals, ruthenium has shown the highest SCR activity for NOx. The high oxidation state of Ru and Ir allow them to trap NOx more easily and thus to form N₂ more efficiently. Ruthenium and iridium are also less expensive than Rh, about one order of magnitude lower than Rh, based on their current market price.

Despite their useful characteristics, it was recognized early on that there were two major limitations that prevented the use of Ru and Ir for catalyst applications at high temperatures. First, these two metals are volatile at high temperature in an oxidizing atmosphere. Finely dispersed Ir or Ru metal particles are first oxidized to high valence-state oxides such as RuO₄ and IrO₃, which evaporate and cause precious metal (PM) loss at high temperatures. Second, the evaporated oxides are toxic, especially RuO₄, which is a major environmental concern.

There have been extensive efforts in the last four decades to stabilize Ru and Ir, however, with only limited success. The basic strategy for stabilization is to form a mixed oxide compound of Ru or Ir with other non-volatile metals, in particular to form single-phase, multi-metal composite perovskite compounds.

Despite the progress made in the last four decades, there is still no significant utilization of Ru or Ir in high temperature catalysis, especially in the automotive catalyst industry. Thus, it would be desirable to provide materials, chemical compositions, and production processes which yield Ru and Ir catalytic materials for use in the automotive and other high temperature catalyst industries. It would be desirable if such materials exhibited one or more of the following properties: more stable, efficient, cost-effective, easy to produce, and environmentally friendly at high temperatures.

### SUMMARY

One or more embodiments of the present invention pertain to compounds containing one or more of ruthenium and iridium. In one aspect, a method includes incorporating ruthenium or iridium in a non-single phase perovskite composition. Such incorporation allows enrichment of the precious metal on the surface of a perovskite structure, thus allowing a more efficient use of the precious metal. The preparation and chemical composition used in the non-single phase Ru- and Ir-containing perovskite materials produced more cost effectively compared to existing materials, and also, catalysts prepared using the inventive material appear to be more active than existing materials.

Accordingly, one aspect of the present invention is directed to a non-single phase perovskite-type bulk material comprising a surface region of the material enriched with one or more of Ru and Ir relative to the bulk material. Underlying the surface region of the material is an interior region, the combination of which constitutes the bulk material.

The enriched surface region can comprise a mixed perovskite structure with the nominal formula (1):

AB₁₋ₓMₓO₃+ABO₃ (1)

wherein A is selected from the group consisting of Li, Na, K, Rb, Cs, Ca, Mg, Ba, Sr, Ga, In, Ti, Si, Ge, Sn, Pb, Sb, Bi, Sc, Y, one or more rare earth elements, and combinations thereof, B is selected from the group consisting of Ti, V, Cr, Mn, Fe, Co, Ni, Zr, Nb, Mo, Hf, Ta, W, B, Al and combinations thereof, M represents one or more elements selected from the platinum group metals consisting Ru and Ir; and x represents the following condition: 0<x≦0.1.

The interior region can comprise a perovskite structure with the nominal formula (2):

ABO₃ (2)

wherein A and B are as above. In illustrative embodiments, A is La and B is Al.

In one or more embodiments, non-single phase perovskite-type materials disclosed herein exhibit substantially no evaporative volatility or loss of the one or more of Ru and Ir following thermal aging in excess of 800° C. In particular embodiments, the surface enriched perovskite-type materials exhibit substantially no evaporative loss of the one or more of Ru and Ir following thermal aging in air for at least four hours or hydrothermal aging in 10% water vapor for at least about four hours, for example 12 hours at temperatures up to about 1050° C., for example 1100° C., and thermal aging up to about 1100° C. In specific embodiments, at least 50% of Ir in the surface region is in the valence state of Ir⁺⁶ and at least 50% of Ru in the surface region is in the valence state of Ru⁺⁸.

A second aspect of the present invention is directed to the preparation of non-single phase, surface enriched perovskite material. The synthesis comprises forming a precious metal-free perovskite precursor, impregnating the precursor with an Ir- and/or Ru-containing aqueous solution, and drying and calcining the impregnated precursor at time and temperature sufficient to produce a non-single phase perovskite-type material surface enriched with Ir and/or Ru.

According to various embodiments, at least two methods can be used in the preparation of a precious metal-free perovskite precursor. One embodiment involves mixing of hydrated soluble salts of equal molar amounts of the A and B elements, stirring the mixture occasionally while drying to remove all the free moisture, grinding the solid mixture into powder, and then calcining the powder at about 500 to 650° C. to remove the nitrate or other volatile groups. In another embodiment, salts of equal molar amounts of the A and B elements are co-precipitated in an aqueous solution by addition of a neutralizing agent, washing, and drying and calcining the solid at about 500 to 650° C. In specific embodiments, up to 20% excess of A salt than that of B salt may be included based on final composition requirements. Further embodiments are directed to forming a washcoat slurry with the material and applying the washcoat to a substrate, for example, a honeycomb substrate.

A third aspect of the present invention is directed to a catalytic article comprising a substrate coated with a non-single phase perovskite-type material whose surface region is enriched with one or more of Ir and Ru. The catalytic article can be prepared by coating a substrate with a slurry of the non-single phase, surface enriched perovskite-type material and drying and calcining the article. The slurry can optionally include other standard catalyst components, such as alumina and ceria-zirconia. The non-single phase, surface enriched perovskite-type material can be used by itself or mixed with other catalytically active materials, such as standard precious metal/alumina materials. The catalytic article finds utility in the reduction of NOx in automotive exhaust emissions, as well as other catalytic reactions.

### BRIEF DESCRIPTION OF THE DRAWINGS

FIG. 1 depicts a non-single phase, surface enriched perovskite-type material according to an embodiment of the present invention;

FIG. 2 shows an X-ray diffraction (XRD) powder pattern of a non-single phase, surface enriched perovskite-type material according to an embodiment of the present invention;

FIG. 3 shows an XRD powder pattern of another non-single phase, surface enriched perovskite-type material according to an embodiment of the present invention;

FIG. 4 shows the evaporative stability of precious metal in a non-single phase, surface enriched perovskite-type material according to an embodiment of the present invention compared to another material;

FIG. 5 shows the evaporative stability of precious metal in a non-single phase, surface enriched perovskite-type material according to another embodiment of the present invention compared to another material;

FIG. 6 shows the NOx conversion activity of a non-single phase, surface enriched perovskite-type material according to an embodiment of the present invention compared with other materials;

FIG. 7 shows the NOx lightoff activity of a non-single phase, surface enriched perovskite-type material according to the embodiment in FIG. 6 compared with other materials;

FIG. 8 shows the NOx conversion activity of a non-single phase, surface enriched perovskite-type material according to another embodiment of the present invention compared to other materials;

FIG. 9 shows the NOx lightoff activity of a non-single phase, surface enriched perovskite-type material according to the embodiment in FIG. 8 compared with other materials;

FIG. 10 shows the NOx conversion activity of a non-single phase, surface enriched perovskite-type material according to an embodiment of the present invention during redox cycling;

FIG. 11A-D shows transmission electron microscopy (TEM) graphs of a non-single phase, surface enriched perovskite-type material according to the embodiment in FIG. 10 during redox cycling;

FIG. 12 shows TEM graphs of a comparative material during redox cycling; and

FIG. 13A-B shows TEM graphs of another comparative material during redox cycling.

### DETAILED DESCRIPTION

Before describing several exemplary embodiments of the invention, it is to be understood that the invention is not limited to the details of preparation or process steps set forth in the following description. The invention is capable of other embodiments and of being practiced or being carried out in various ways known to the skilled artisan.

One or more embodiments of the invention pertain to perovskite compositions. Perovskite compositions are nominally designated as ABO₃ having a close packed, face-centered cubic crystal structure with the larger metal ion A sitting on the corners of the cubic cell and the smaller metal B in the center. For perovskites containing rare earth and transition metals, A represents a rare earth metal, such as lanthanum, neodymium, cerium, or the like, and B represents a transition metal such as cobalt, iron, nickel, or the like. One property of perovskites is that when electric fields are applied to perovskites, the smaller center ion B can move within the crystal lattice without breaking bonds. For a catalytic reaction, a redox cycle occurs under a lean or rich atmosphere when the oxygen to fuel ratio of the exhaust gas is either above or below unit. The usefulness of a perovskite structure is that, in an oxidizing atmosphere at high temperature, it allows ruthenium or iridium to enter the perovskite structure and occupy the B-site. The bonding between A and B sites is so strong that it prevents the metal from evaporating into the air. In a reducing atmosphere, the precious metal is reduced and reorganized into a metal cluster and servers as the catalytic active sites. It has been demonstrated that the metal movement in and out of the perovskites is a reversible process.

Applicants have found that enrichment of the platinum group metal, more particularly Ru and/or Ir, in the surface portion of the perovskite-type material provides a more stable and cost-efficient use of the precious metals while having higher catalytic activity as compared to precious metal catalysts supported on conventional supports such as alumina.

Accordingly, one aspect of the present invention is directed to a non-single phase perovskite-type material comprising one or more of Ru and Ir, wherein the surface region of the material is enriched with one or more of Ru and Ir relative to the bulk material. Underlying the surface region of the material is an interior region, the combination of the interior region and surface region constituting the bulk material. As demonstrated in the examples below, the surface enrichment of one or more of Ru and Ir relative to the bulk material can be verified by X-ray photoelectron spectroscopy (XPS), which is suitable for determining average outer surface compositions, and X-ray fluorescence (XRF), which is suitable for determining bulk compositions. Thus, surface enrichment can be demonstrated by an XPS/XRF ratio of >1. In specific embodiments, the surface enrichment ratio is >1, more specifically >2.

According to one or more embodiments, the enriched surface region of the non-single phase perovskite-type material can comprise a mixed perovskite structure with the nominal formula (1):

AB₁₋ₓMₓO₃+ABO₃ (1)

where A is selected from the group consisting of Li, Na, K, Rb, Cs, Ca, Mg, Ba, Sr, Ga, In, Tl, Si, Ge, Sn, Pb, Sb, Bi, Sc, Y, one or more rare earth elements, and combinations thereof, B is selected from the group consisting of Ti, V, Cr, Mn, Fe, Co, Ni, Zr, Nb, Mo, Hf, Ta, W, B, Al and combinations thereof, M represents one or more elements selected from the platinum group metals consisting Ru and Ir; and x represents the following condition: 0<x≦0.1.

The interior region of the non-single phase perovskite-type material can comprise a perovskite structure with the nominal formula (2):

ABO₃ (2)

wherein A and B are as above.

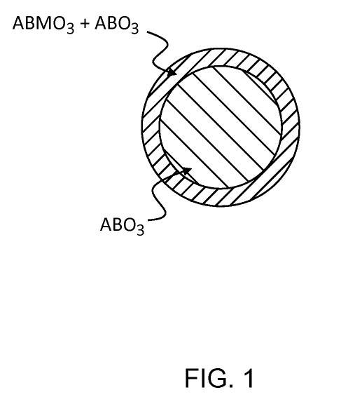

For demonstrative purpose, lanthanum is used as the A element in the examples given below since it is a simple, low cost, environmental friendly, commonly used element in perovskite structures, and effective for Ru and Ir stabilizations. Aluminum is used as the B element in the examples below because of its simplicity, stability during a redox process, inertness toward Ru and Ir, low cost, environmental friendliness, and extensive usage in catalyst industries. The structure of the non-single phase perovskite material is demonstrated pictorially in FIG. 1.

The non-single phase, surface enriched perovskite material can be prepared by forming a precious metal-free perovskite precursor, impregnating the precursor with an Ir- and/or Ru-containing aqueous solution, and drying and calcining the impregnated precursor at a time and temperature sufficient to produce a non-single phase perovskite-type material surface enriched with Ir and/or Ru.

The metal-free perovskite precursor can be prepared, for example, by a co-precipitation process. According to this process, an aqueous mixed salt solution containing salts of the above-mentioned elements for A and B of formulas (1) and (2) is prepared. The aqueous mixed salt solution is co-precipitated by the addition of a neutralizing agent, and the resulting co-precipitate is washed, dried, ground and subjected to heat treatment to form a highly mixed perovskite precursor.

The precursor is then impregnated with an aqueous salt solution of Ru, Ir, or combinations thereof (corresponding to M of formula (1)), dried, ground and subjected to a second heat treatment (calcination) for a time and temperature sufficient to form the non-single phase, surface enriched perovskite-type material. It is noted that although the amorphous precursor is not a perovskite itself after the first heat treatment, co-precipitation is necessary for the high stability of rutheniun and iridium. In other words, evaporation of iridium and ruthenium would occur if they were dispersed on a physical mixture of lanthanum and aluminum oxides, and then calcined. It is also noted that the perovskite precursor cannot be a perovskite by itself. In other words, iridium and ruthenium would evaporate after the precious metal was dispersed on an ABO₃ perovskite support.

Examples of the salts of the above-mentioned elements for A and B of formulas (1) and (2) are inorganic salts such as sulfates, nitrates, and chlorides; and organic salts such as acetates and oxalates, of which inorganic salts are preferred, and nitrates are particularly preferred. The aqueous mixed salt solution can be prepared, for example, by adding the salts of the elements to water and mixing them with stirring.

The aqueous mixed salt solution is then co-precipitated by adding the neutralizing agent thereto. The neutralizing agent includes, but is not specifically limited to, inorganic bases such as hydroxide, carbonate and ammonium salts of alkaline earth metals, though ammonium hydroxide is preferred, and organic bases including amines such as ethanol amine. The neutralizing agent is added dropwise to the aqueous mixed salt solution while stirring so that the solution after the addition of the neutralizing agent has a pH of about 5 to 10, specifically 7-9. This slow and dropwise addition of the basic solution while stirring efficiently and uniformly co-precipitates the salts of the elements.

The resulting co-precipitate is washed with water, dried typically by vacuum drying, heat drying at 110° C., spray drying, or forced-air drying, ground thoroughly, and subjected to heat treatment typically at about 450-650° C., specifically at about 500 to 600° C., for about 0.5-24 hours in air. In this fashion, a perovskite precursor with a close contact of A and B elements is prepared. Washing is beneficial not only because it removes any unreacted soluble species, but also because it creates more pores and makes the final powder easier to be ground, which further increases the thermal stability of iridium and ruthenium.

Another suitable method involves mixing of the salts of A and B that are in hydrated forms by solid-state grinding, followed by heating, grinding, drying, more grinding, and then calcination, which will also produce the perovskite precursor. When heated, the crystal water from the salts of A and B is released and wets the solid mixture, which helps form the close contact of A and B elements. Although the perovskite precursor is amorphous and does not have a perovskite structure, it is not a simple physical mixture of the oxides of the A and B elements. The closeness of A and B in the precursor leads to formation of the non-single phase perovskite structure after a precious metal salt is dispersed on the surface of the precursor and then calcined at a higher temperature, usually above 700° C.

The perovskite precursor material is then impregnated with an aqueous salt solution of Ru, Ir, or combinations thereof. Examples of the salts of Ru and Ir are inorganic salts such as nitrates, chlorides, and sulfate; and organic salts such as acetates, amine, and oxalates. The precious metal salts or oxides can be added to the perovskite precursors by other methods such as spray-drying or solid-state grinding.

The precious metal-impregnated perovskite precursor material is dried typically by vacuum drying, heat drying at 110° C., spray drying, or forced-air drying, ground thoroughly, and subjected to a second heat treatment typically at about 600 to 1200° C., specifically at about 700 to 1000° C., for about 0.5-24 hours in air. In this fashion the non-single phase, surface enriched perovskite-type material is formed. The perovskite structure of the material can be confirmed by X-ray powder diffraction (XRD) analysis as described more fully below.

As shown in more detail below, the resulting non-single phase, surface enriched perovskite-type material exhibits substantially no evaporative volatility or loss of Ru and Ir at temperatures up to about 1100° C. (e.g., 1093° C.) in air or 1050° C. in the presence of 10% water vapor and displays high NOx reduction activity. By the term “substantially no evaporative volatility or loss” is meant that less than about 1%, specifically less than 0.5%, and more specifically less than about 0. 1% evaporative loss of Ru and Ir is observed following a thermal aging at 1093° C. in air for 4 hours or a hydrothermal aging of the material at 1050° C. in 10% water vapor for 12 hours. As such, the material finds utility as a catalyst for the reduction of NOx in automotive exhaust emissions. In a specific embodiment, the materials of the present invention may be placed as a washcoat on a filter, for example, a wall-flow type filter. In a highly specific embodiment, a washcoat may be placed on a wall-flow filter having a plurality of longitudinally extending passages formed by longitudinally extending walls bounding and defining said passages. The passages include inlet passages that have an open inlet end and a closed outlet end, and outlet passages that have a closed inlet end and an open outlet end. The wall flow filter may function as an SCR catalyst. SCR catalysts on filters are disclosed in U.S. Pat. No. 7, 229, 597, the entire content of which is incorporated herein by reference. Catalytic materials may be present on the inlet side of the element wall alone, the outlet side alone, both the inlet and outlet sides, or the wall itself may consist all, or in part, of the catalytic material. This invention includes the use of one or more layers of catalytic materials and combinations of one or more layers of catalytic materials on the inlet and/or outlet walls of the element. To coat the wall flow substrates with the catalyst composition, the substrates are immersed vertically in a portion of the catalyst slurry such that the top of the substrate is located just above the surface of the slurry. In this manner slurry contacts the inlet face of each honeycomb wall, but is prevented from contacting the outlet face of each wall. The sample is left in the slurry for about 30 seconds. The substrate is removed from the slurry, and excess slurry is removed from the wall flow substrate first by allowing it to drain from the channels, then by blowing with compressed air (against the direction of slurry penetration), and then by pulling a vacuum from the direction of slurry penetration. By using this technique, the catalyst slurry permeates the walls of the substrate, yet the pores are not occluded to the extent that undue back pressure will build up in the finished substrate. As used herein, the term “permeate” when used to describe the dispersion of the catalyst slurry on the substrate, means that the catalyst composition is dispersed throughout the wall of the substrate.

The material is also useful for other catalytic applications such as oxidation of CO and hydrocarbons, steam reforming, hydrogenation and dehydrogenation, water-gas shift, and so forth. In this respect, the material can be incorporated into a three-way catalyst for gasoline engines or a diesel oxidation catalyst for diesel engines.

The non-single phase, surface enriched perovskite-type material may be used as is, or may take the form of pellets or particles which may be of uniform composition or may take a supported form with active ingredient being dispersed through or present as a coating on the individual bodies. For example, the material can be extruded or molded into monolithic bodies including honeycombs consisting of channels running the length of the body, and thin interconnected walls. The material may also be formed into an open-cell foam.

In a specific embodiment, the non-single phase, surface enriched perovskite-type material is used in the form of a coating on a suitable refractory support to form a catalytic article. Such supports can be composed solely or primarily of ceramic compositions, such as a cordierite monolithic honeycomb, gamma alumina, silicon carbide, titania, zirconia, and other such refractory materials, or of metallic surface.

Application of the non-single phase, surface enriched perovskite-type material can occur via a washcoat to a substrate, as known in the art. In this case, the catalytic material is slurried, optionally with other standard catalyst components such as alumina and ceria-zirconia, and coated onto a monolith substrate, dried, and calcined to produce the final catalytic article. The non-single phase, surface enriched perovskite-type material can be used by itself or mixed with other catalytic materials, such as standard precious metal/alumina materials. The non-single phase, surface enriched perovskite-type material can be also used at different locations in the catalyst, e.g., in another layer or zone, that is physically separated from other catalytic components.

The substrate may be any of those materials typically used for preparing catalysts, and will usually comprise a ceramic or metal honeycomb structure. Any suitable substrate may be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material is disposed as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 400 or more gas inlet openings (i.e., cells) per square inch of cross section.

The substrate can also be a wall-flow filter substrate, where the channels are alternately blocked, allowing a gaseous stream entering the channels from one direction (inlet direction), to flow through the channel walls and exit from the channels from the other direction (outlet direction). If a wall flow substrate is utilized, the resulting system will be able to remove particulate matter along with gaseous pollutants. The wall-flow filter substrate can be made from materials commonly known in the art, such as cordierite, aluminum titanate or silicon carbide. It will be understood that the loading of the catalytic composition on a wall flow substrate will depend on substrate properties such as porosity and wall thickness, and typically will be lower than loading on a flow through substrate.

The ceramic substrate may be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alpha-alumina, an aluminosilicate and the like.

The substrates useful for the catalysts of embodiments of the present invention may also be metallic in nature and be composed of one or more metals or metal alloys. The metallic substrates may be employed in various shapes such as corrugated sheet or monolithic form. Suitable metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The surface or the metal substrates may be oxidized at high temperatures, e.g., 1000° C. and higher, to improve the resistance to corrosion of the alloys by forming an oxide layer on the surfaces the substrates. Such high temperature-induced oxidation may enhance the adherence of the refractory metal oxide support and catalytically promoting metal components to the substrate.

In alternative embodiments, the catalyst compositions may be deposited on an open cell foam substrate. Such substrates are well known in the art, and are typically formed of refractory ceramic or metallic materials.

Catalysts made in accordance with embodiments of the invention utilizing the inventive materials can find use in a wide variety of applications, for example, for selective catalytic reduction of nitrogen oxides (NOx) and other catalytic applications such as oxidation of CO and hydrocarbons, steam reforming, hydrogenation and dehydrogenation, water-gas shift, and so forth. In this respect, the material can be incorporated into a three-way catalyst for gasoline engines or a diesel oxidation catalyst for diesel engines. Thus, according to one or more aspects of the present invention, methods and systems are provided that utilize catalyst substrates, for example, honeycomb substrates having effective amounts of the catalytic materials described herein deposited on the substrate to achieve the desired catalytic function. Such as system would include a source of an exhaust gas stream, for example, a gasoline engine, a diesel engine, a utility boiler, an industrial boiler, or a municipal solid waste boiler, with the catalytic article comprising the substrate having the catalytic material thereon disposed in the exhaust gas stream. In automobile exhaust gas treatment systems, the catalytic article is typically disposed within a “can” which is located within the exhaust conduit.

Specific embodiments according to the present invention will now be described in the following examples. The examples are illustrative only, and are not intended to limit the remainder of the disclosure in any way. Although the instant specification places emphasis on NOx reduction, the non-single phase, surface enriched perovskite-type materials are useful for other catalytic reactions, such as oxidation of CO and hydrocarbons and steam reforming of CH₄ and other organic compounds.

### EXAMPLES

### Example 1

An Ir-based non-single phase, surface enriched perovskite-type material comprising LaAl_{0.99}Ir_{0.01}O₃ was prepared as follows:

202.6 g of La(NO₃)₃.6H₂O was dissolved into 750.0 g of dIH₂O to yield solution 1. 175.5 g of Al(NO₃)₃.9H₂O was dissolved into 150.0 g of dIH₂O to yield solution 2. Solutions 1 and 2 were mixed and stirred for 5 minutes. NH₄OH was added dropwise to a pH of 8.0-8.5 and stirred for 5 minutes. The resulting mixed oxide coprecipitate was filtered, washed twice with warm water, dried overnight at 110° C., ground thoroughly, and calcined at 550° C. for 2 hours to yield Powder 1.

2.88 g iridium acetate (4.19% solution, BASF) was mixed with 1.50 g dIH₂O to yield solution 3. 12 g of Powder 1 was then impregnated with solution 3 drop-wise by standard incipient wetness method. The impregnated material was dried overnight at 110° C., ground thoroughly, and calcined at temperatures ranging from 500-1100° C. for 4 hours to yield Powder 2. The impregnated sample that had been calcined at 800° C. was also steam-aged at 1050° C. with 10% H₂O in air for 12 hours.

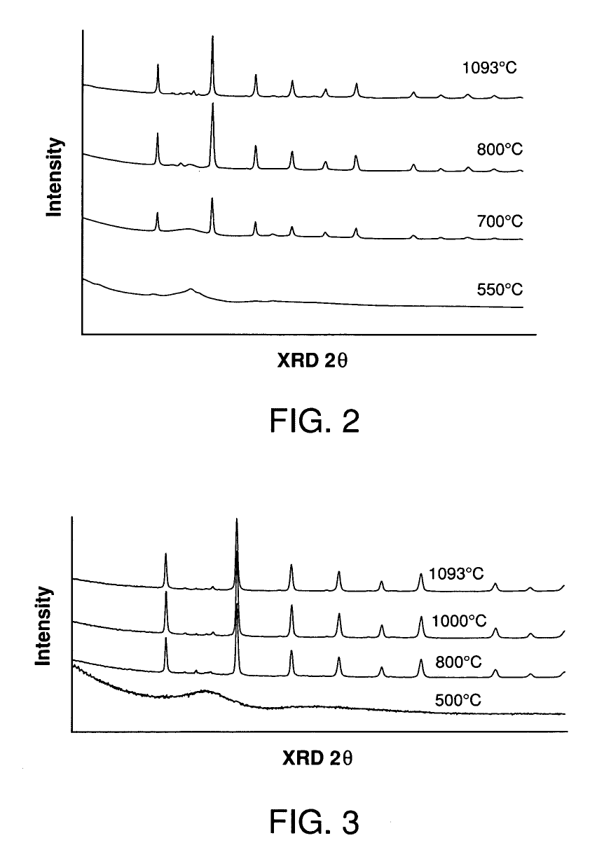

XRD analysis was performed on Powder 2. As shown in FIG. 2, a perovskite-type structure was obtained as early as 700° C., with no structural change up to 1093° C. No separated Ir or Ir oxide peaks were identified when compared to XRD analysis of a pure iridium oxide or a perovskite-type material lacking Ir, indicating that iridium had been incorporated into the perovskite structure.

### Example 2

An Ru-based non-single phase, surface enriched perovskite-type material comprising LaAl_{0.99}Ru_{0.01}O₃ was prepared as follows:

0.54 g ruthenium nitrosyl nitrate aqueous solution (9.3% Ru, BASF) was mixed with 1.3 g dIH₂O to yield solution 1. 10.0 g of Powder 1 from Example 1 was then impregnated with solution 1 drop-wise by standard incipient wetness method. The impregnated material was dried overnight at 110° C., ground thoroughly, and calcined at temperatures ranging from 500-1093° C. for 4 hours to yield Powder 3. The impregnated sample that had been calcined at 8000 C was also steam-aged at 1050° C. with 10% H₂O in air for 12 hours.

XRD analysis was performed on Powder 3. As shown in FIG. 3, a perovskite-type structure was obtained as early as 800° C., with no structural change up to 1093° C. No separated Ru or Ru oxide peaks were identified when compared to XRD analysis of a perovskite-type material lacking Ru, indicating that ruthenium had been incorporated into the perovskite structure.

### Comparative Example 1

A Standard Ir-dispersed alumina Material was Prepared as Follows:

2.88 g iridium acetate aqueous solution (4.19% solution, BASF) was mixed with 5.5 g dIH₂O to yield solution 1. 12 g of La-stabilized alumina (SBA150L4 from Sasol) was then impregnated with solution 1 drop-wise by standard incipient wetness method. The impregnated material was dried overnight at 110° C., ground thoroughly, and calcined at temperatures ranging from 500° C. for 2 hours, ground again, and further calcined at 800 or 1000° C. in air for 4 hours to yield comparative Powder 1.

### Comparative Example 2

### A Standard Ru-Dispersed Alumina Material was Prepared as Follows:

3.36 g ruthenium nitrosyl nitrate aqueous solution (1.5% Ru, BASF) was mixed with 4.1 g dIH₂O to yield solution 1. 10.5 g of La-stabilized alumina (SBA150L4 from Sasol) was then impregnated with solution 1 drop-wise by standard incipient wetness method. The impregnated material was dried overnight at 110° C., ground thoroughly, and calcined at temperatures ranging from 500° C. for 2 hours, ground again, and further calcined at 800 or 1000° C. in air for 4 hours to yield comparative Powder 2.

### Comparative Example 3

### A Standard Pt-Dispersed Alumina Material was Prepared as Follows:

1.124 g platinum nitrate aqueous solution (13.46% Pt, BASF) was mixed with 10.2 g dIH₂O to yield solution 1. 15.75 g of La-stabilized alumina (SBA150L4 from Sasol) was then impregnated with solution 1 drop-wise by standard incipient wetness method. The impregnated material was dried overnight at 110° C., ground thoroughly, and calcined at 500° C. for 2 hours, ground again, and further calcined at 800 or 1000° C. in air for 4 hours to yield comparative Powder 3.

### Comparative Example 4

### A Standard Pd-Dispersed Alumina Material was Prepared as Follows:

0.375 g palladium nitrate aqueous solution (20.59% Pd, BASF) was mixed with 11.1 g dIH₂O to yield solution 1. 15.75 g of La-stabilized alumina (SBA150L4 from Sasol) was then impregnated with solution 1 drop-wise by standard incipient wetness method. The impregnated material was dried overnight at 110° C., ground thoroughly, and calcined at 500° C. for 2 hours, ground again, and further calcined at 800 or 1000° C. in air for 4 hours to yield comparative Powder 4.

### Comparative Example 5

### A Standard Rh-Dispersed Alumina Material was Prepared as Follows:

0.50 g rhodium nitrate aqueous solution (10.05% Rh, BASF) was mixed with 7.1 g dIH₂O to yield solution 1. 10.50 g of La-stabilized alumina (SBA150L4 from Sasol) was then impregnated with solution 1 drop-wise by standard incipient wetness method. The impregnated material was dried overnight at 110° C., ground thoroughly, and calcined at 500° C. for 2 hours, ground again, and further calcined at 800 or 1000° C. in air for 4 hours to yield comparative Powder 4.

### Test Example 1

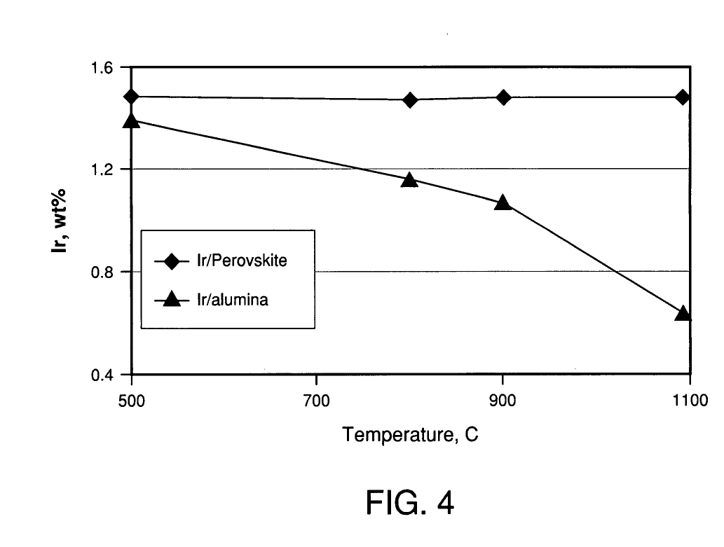

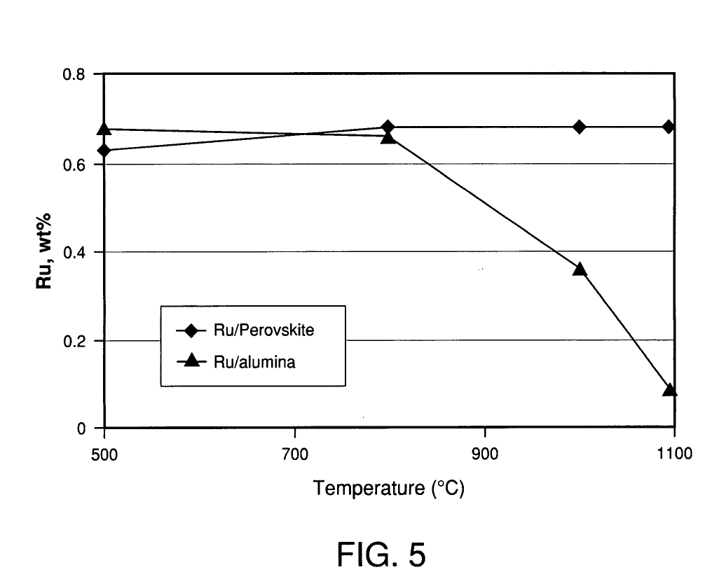

Powders obtained in Examples 1 and 2 and Comparative Examples 1 and 2 were calcined at various temperatures and measured for iridium stability by standard X-ray fluorescence microscopy (XRF) or induced coupling plasma (ICP) spectra. As shown in FIG. 4, the non-single phase, surface enriched perovskite-type material from Example 1 exhibited little evaporative loss of Ir at temperatures up to 1093° C. in air or 1050° C. with the presence of steam, whereas the standard Ir-dispersed alumina material from Comparative Example 1 exhibited substantial Ir loss at temperatures above 800° C. Similarly, as shown in FIG. 5, the non-single phase, surface enriched perovskite-type material from Example 2 exhibits little evaporative loss of Ru at temperatures up to 1093° C. in air or 1050° C. with the presence of steam, whereas the standard Ru-dispersed alumina material from Comparative Example 2 exhibited substantial Ru loss at temperatures above 800° C. A small amount of precious metal loss was observed in the non-single phase, surface enriched perovskite-type material at temperatures above 800° C. when the coprecipitate was not washed with warm water, indicating that the wash step is necessary to prevent evaporation of the precious metal by removal of soluble alumina.

### Test Example 2

Powders obtained in Example 1 and Comparative Example 1 and calcined at 8000 C for 4 hours were measured for surface amounts of precious metal and oxidation valence state by standard X-ray photoelectron spectroscopy (XPS). The materials were also measured for bulk amounts of precious metals using X-ray fluorescence (XRF) or ICP (Induced Coupling Plasma) spectra. The results are shown below in Table 1.

TABLE 1

| | | | Ir(Perovskite)/ |
|---|---|---|---|
| | Ir/Perovskite | Ir/Alumina | Ir(Alumina) |
| XRF (wt %) | 1.47 | 1.16 | 1.3 |
| XPS (wt %) | 4.27 | 1.58 | 2.7 |
| XPS/XRF | 2.9 | 1.4 | 2.1 |

As can be seen from Table 1, the surface amount of Ir in the non-single phase, surface enriched perovskite-type material from Example 1 (as measured by XPS) was more than 2 times in the standard Ir-dispersed alumina material from Comparative Example 1, whereas the total amount of Ir in the material (as measured by XRF) was similar. Furthermore, the XPS/XRF ratio of 2.9 in column 1 confirmed surface enrichment of Ir in the non-single phase, perovskite-type material from Example 1.

In addition, the relative intensity of oxidation states Ir⁺²:Ir⁺⁴:Ir⁺⁶ in the non-single phase, surface enriched perovskite-type material as determined by XPS was 10:18:82, whereas the relative intensity of oxidation states Ir⁺²:Ir⁺⁴:Ir⁺⁶ in the standard Ir-dispersed alumina material was 67:33:0. The absence of Ir⁺⁶ species in Ir/alumina was expected since surface IrO₃ is volatile. The predominance of Ir⁺⁶ in the non-single phase, surface enriched perovskite-type material from Example 1 was not expected and is consistent with the hypothesis of Ir being located in the B site (6-fold coordination) of the perovskite lattice.

Powders obtained in Example 2 and Comparative Example 2 and calcined at 800° C. for 4 hours were measured for surface amounts of precious metal and oxidation valence state by XPS. The materials were also measured for bulk amounts of precious metals using XRF. The results are shown below in Table 2.

TABLE 2

| | | | Ru(perovskite)/ |
|---|---|---|---|
| | Ru/Perovskite | Ru/Alumina | Ru(alumina) |
| XRF | 0.68 | 0.66 | 1.0 |
| XPS | 0.98 | 0.28 | 3.5 |
| XPS/XRF | 1.4 | 0.4 | 3.5 |

As can be seen from Table 2, the surface amount of Ru in the non-single phase, surface enriched perovskite-type material from Example 2 (as measured by XPS) was more than 3 times in the standard Ru-dispersed alumina material from Comparative Example 2, whereas the total amount of Ru in the material (as measured by XRF) was similar. Furthermore, the XPS/XRF ratio of 1.4 in column 1 confirmed surface enrichment of Ru in the non-single phase, perovskite-type material from Example 2, while ruthenium in the Ru/alumina sample is concentrated in the inner part of the particle.

In addition, the relative intensity of oxidation states Ru⁰:Ru⁺⁶ :Ru⁺⁸ in the non-single phase, surface enriched perovskite-type material as determined by XPS was 0:37:63, whereas the relative intensity of oxidation states Ru⁰:Ru⁻⁶:Ru⁺⁸ in the standard Ir-dispersed alumina material was 67:33:0. Again, the predominance of Ru⁺⁸ in the non-single phase, surface enriched perovskite-type material from Example 2 is consistent with its occupancy in the B site (6-fold coordination) of the perovskite lattice after being oxidized.

### Test Example 3

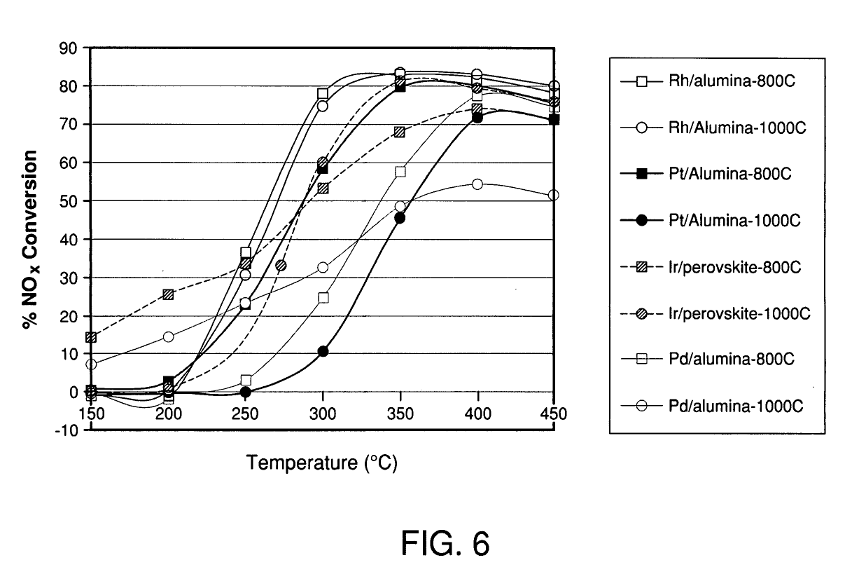

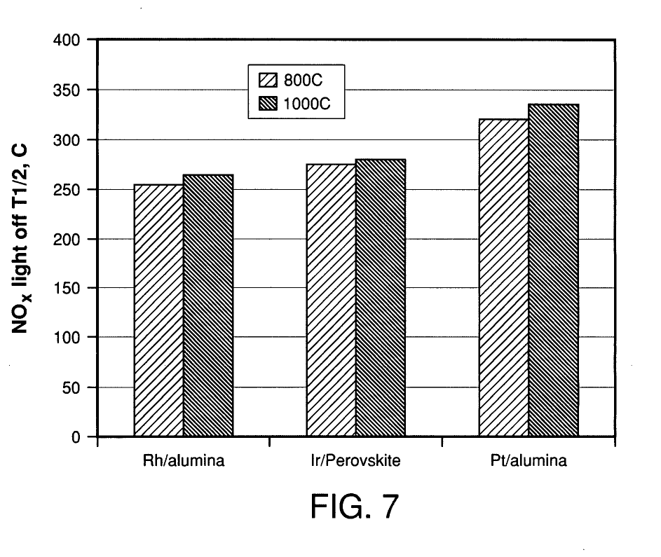

Powders obtained in Example 1 and Comparative Examples 3-5 and calcined at 800° C. for 4 hours were measured for NOx activity. Each of the samples was oxidized at 800° C. or 1000° C. in air for 4 hours and measured for NO reduction activity in a high throughput reactor. The samples were pre-reduced in the reactor at 4500 C under a 4% H₂/He atmosphere for 0.5 hour and measured for NO conversion. The reactant gas consisted of 0.225% CO, 0.126% NO, and 5% H₂O balanced by He. The total flow space velocity was about 50,000 hr⁻¹. As shown in FIG. 6, the non-single phase, Ir surface enriched perovskite-type material from Example 1 showed higher and more stable NOx conversion activity than the standard Pt-dispersed and Pd-dispersed alumina materials from Comparative Examples 3 and 4, respectively, and similar NOx conversion activity to that of the standard Rh-dispersed alumina material from Comparative Example 5. As shown in FIG. 7, the non-single phase, Ir surface enriched perovskite-type material had lower NOx lightoff temperatures (temperature at which NO concentration is reduced by 50%) than the Pt-dispersed alumina material, and similar lightoff temperatures to that of the Rh-dispersed alumina material. The non-single phase, Ir surface enriched perovskite-type material has higher thermal stability than both the Pt- and Rh-dispersed alumina catalysts as the former showed a constant NOx reduction activity at both 800 and 1000° C., while the later showed lower catalytic activity at higher temperature.

### Test Example 4

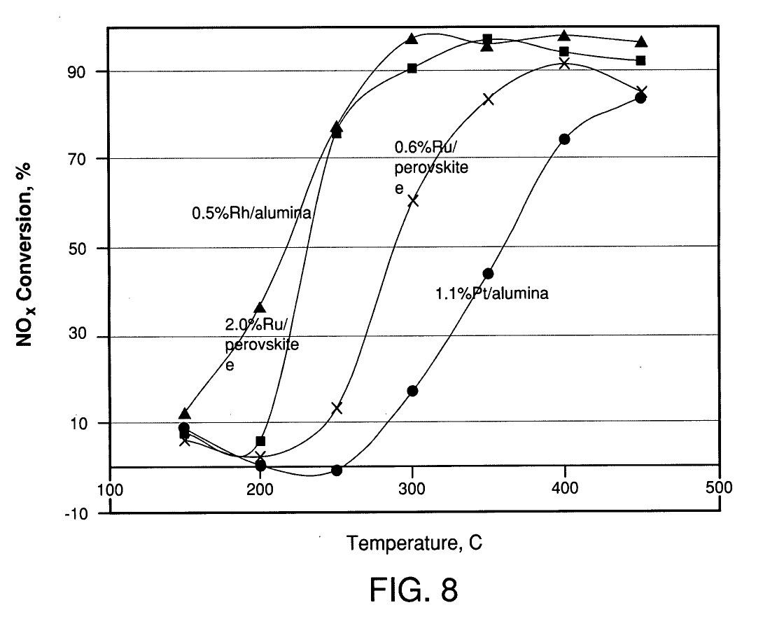

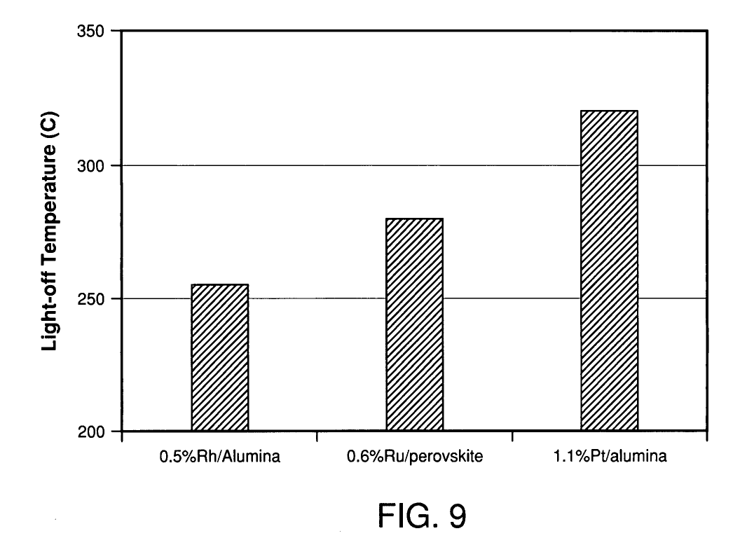

Powders obtained in Example 2 and Comparative Examples 3 and 5 and calcined at 800° C. for 4 hours were measured for NOx activity. Each of the samples was oxidized at 800° C. in air for 4 hours and then pre-reduced and measured for their NO reduction activity as described in Test Example 3. As shown in FIG. 8, the non-single phase, Ru surface enriched perovskite-type materials from Example 2 showed higher and more stable NO conversion activity than the standard Pt-dispersed alumina materials from Comparative Example 3, and similar NO conversion activity to that of the standard Rh-dispersed alumina material from Comparative Example 5. As shown in FIG. 9, the non-single phase, Ru surface enriched perovskite-type material had a lower lightoff temperature than the Pt-dispersed alumina material, and similar lightoff temperature to that of the Rh-dispersed alumina material.

### Test Example 5

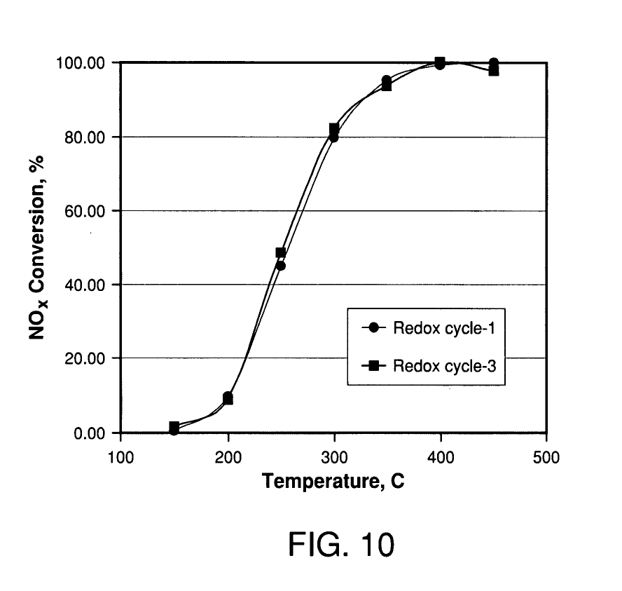

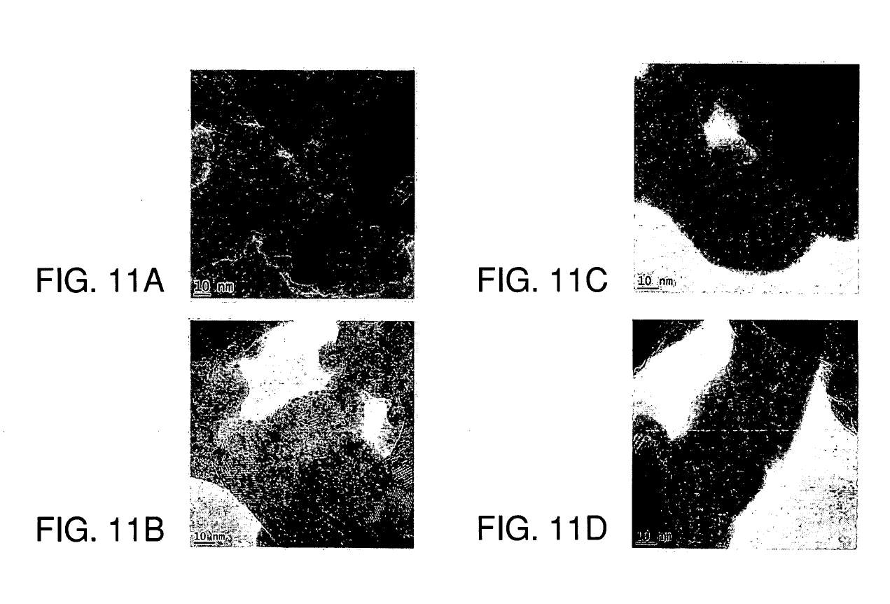

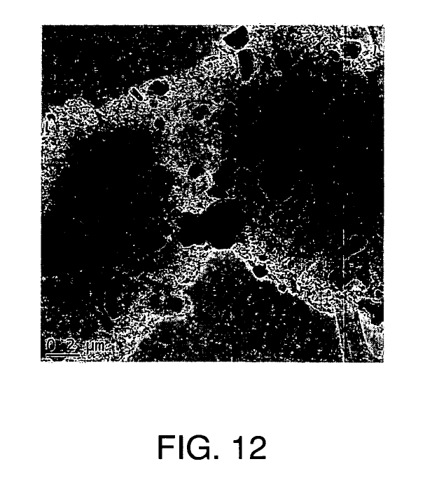

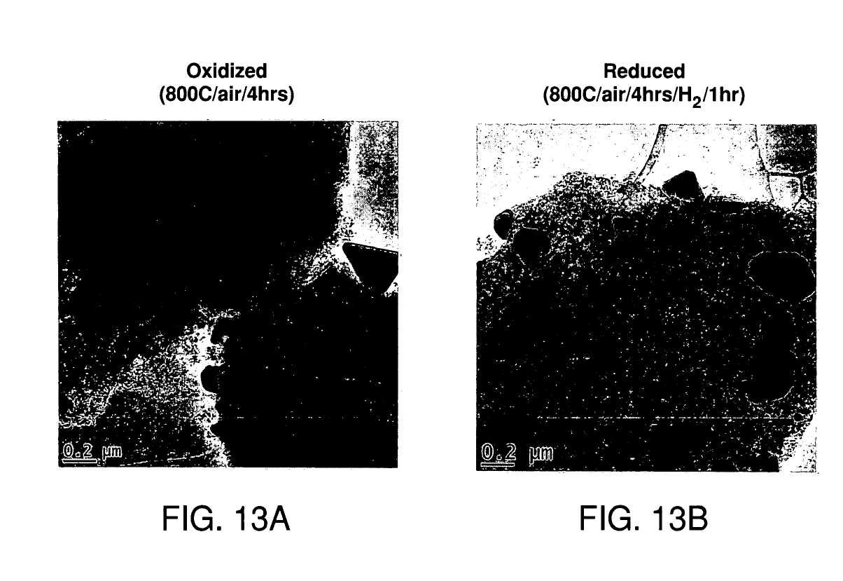

Powder obtained in Example 1 and calcined at 800° C. for 4 hours were measured for NOx activity during redox cycling. Each sample was oxidized at 800° in air for 4 hours, reduced at 800° C. in 7% H₂/N₂ gas for 1 hour (Cycle 1), measured for NOx conversion as described in Testing Example 3, reoxidized at 8000 in air for 4 hours, re-reduced at 800° C. in 7% H₂/N₂ gas for 1 hour (Cycle 2); and re-measured for NOx conversion. As shown in FIG. 10, the non-single phase, Ir surface enriched perovskite-type material from Example 1 showed almost identical NOx conversion activity during the redox cycling. Transmission electron microscopy (TEM) of the powder after each redox cycle showed that the stability of the redox activity was due to the self-regenerative ability of the material. As synthesized under oxidation conditions, the Ir is dispersed throughout the perovskite lattice and no Ir particles appear on the surface, as shown in FIG. 11A. Under reducing conditions, the Ir segregates into metallic nanoparticles (˜2 nm) with high catalytic activity, as shown in FIG. 11B and D. Upon oxidation, the Ir redisperses into the perovskite lattice, with no evidence of sintering into large metal particles, as shown in FIG. 11C. In contrast, the standard Ir-dispersed alumina material from Comparative Example 1 containing 1.4% Ir showed sintering after one redox cycle after aging at 800° C. in air and then 800° C. in H₂, as shown in FIG. 12. Similarly, the standard Pt-dispersed alumina material from Comparative Example 3 also showed sintering after one redox cycle, as shown in FIG. 13A-B. The comparative materials are thus not self-regenerative, exhibiting substantial reduced catalytic activity over time.

All publications cited in the specification, both patent and non-patent, are indicative of the level of skill of those skilled in the art to which this invention pertains. All these publications are fully incorporated herein by reference to the same extent as if each individual publication were specifically and individually indicated as being incorporated by reference.

Reference throughout this specification to “one embodiment,” “certain embodiments,” “one or more embodiments,” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the present invention without departing from the spirit and scope of the invention. Thus, it is intended that the present invention include modifications and variations that are within the scope of the appended claims and their equivalents.

1. A non-single phase perovskite-type bulk material comprising a surface region enriched with one or both Ru and Ir precious metal relative to the bulk material.

2. The non-single phase perovskite-type material of claim 1, wherein the enriched surface region comprises a mixed perovskite structure with the nominal formula (1):
AB₁₋ₓMₓO₃+ABO₃ (1)
wherein A is selected from the group consisting of Li, Na, K, Rb, Cs, Ca, Mg, Ba, Sr, Ga, In, Tl, Si, Ge, Sn, Pb, Sb, Bi, Sc, Y, one or more rare earth elements, and combinations thereof;
B is selected from the group consisting of Ti, V, Cr, Mn, Fe, Co, Ni, Zr, Nb, Mo, Hf, Ta, W, B, Al, and combinations thereof;
M represents one or more elements selected from the platinum group metals including Ru and Ir; and
x represents the following condition: 0<x≦0.1.

3. The non-single phase perovskite-type material of claim 1, wherein the material has a ratio of the precious metal in the surface region to the precious metal in the bulk material of greater than 1 and at least 50% of Ir in the surface region is in the valence state of Ir⁺⁶ and at least 50% of Ru in the surface region is in the valence state of Ru⁺⁸.

4. (canceled)

5. The non-single phase perovskite-type material of claim 3, wherein of the precious metal in the surface region to the precious metal in the bulk material of greater than 2.

6. The non-single phase perovskite-type material of claim 1, wherein the surface region is enriched with Ru and no Ir.

7. The non-single phase perovskite type material of claim 6, wherein at least 50% of Ru in the surface region is in the valence state of Ru⁺⁸.

8. The non-single phase perovskite material of claim 1, wherein the surface region is enriched with Ir and no Ru, and at least 50% of Ir in the surface region is in the valence state of Ir⁺⁶.

9. The non-single phase perovskite-type material of claim 7, wherein of the precious metal in the surface region to the precious metal in the bulk material of greater than 2.

10. The non-single phase perovskite-type material of claim 8, wherein of the precious metal in the surface region to the precious metal in the bulk material of greater than 2.

11. A catalyst comprising the non-single phase perovskite-type material of claim 1 deposited on a substrate.

12. The catalyst of claim 11, wherein the substrate comprises a honeycomb substrate.

13. A non-single phase perovskite-type material comprising one or more of Ru and Ir, wherein the material exhibits substantially no evaporative loss of the one or more of Ru and Ir following a thermal aging at temperatures exceeding about 800° C. for at least about 4 hours.

14. The non-single phase perovskite-type material of claim 13, wherein the material exhibits substantially no evaporative loss of the one or more of Ru and Ir following a thermal aging at temperatures exceeding about 1100° C. in air for at least about 4 hours.

15. The non-single phase perovskite-type material of claim 13, wherein the material exhibits substantially no evaporative of the one or more of Ru and Ir following hydrothermal aging at temperatures up to about 1050° C. in 10% water vapor for 12 hours.

16. The non-single phase perovskite type material of claim 13, wherein the material consists of Ru.

17. The non-single phase perovskite type material of claim 13, wherein the material consists of Ir.

18. A process for preparing a non-single phase, surface enriched perovskite-type bulk material comprising providing a precious metal-free perovskite precursor, impregnating the precursor with one or more of an Ir- and Ru-containing aqueous solution, and drying and calcining the impregnated precursor at time and temperature sufficient to produce the non-single phase perovskite-type material surface enriched with one or more of Ir and Ru.

19. The process of claim 18, wherein the precious metal-free perovskite precursor is provided by co-precipitating an aqueous mixed salt solution comprising salts of A and B and heating the co-precipitate time and temperature sufficient to produce the precious metal-free perovskite precursor,
wherein A is selected from the group consisting of Li, Na, K, Rb, Cs, Ca, Mg, Ba, Ga, In, Tl, Si, Ge, Sn, Pb, Sb, Bi, Sc, Y, one or more rare earth elements, and combinations thereof; and
B is selected from the group consisting of Ti, V, Cr, Mn, Fe, Co, Ni, Zr, Nb, Mo, Hf, Ta, W, B, Al, and combinations thereof.

20. The process of claim 18, wherein the precursor is impregnated with Ir and substantially no Ru.

21. The process of claim 18, wherein the precursor is impregnated with Ru and substantially no Ir.

22. The process of claim 18, further comprising mixing the non-single phase perovskite-type material with a liquid to form a washcoat slurry, and then applying the washcoat slurry to a carrier substrate.

23. The process of claim 22, wherein the carrier substrate comprises a honeycomb substrate.

24. The process of claim 22, wherein the slurry further comprises a second catalyst component selected from refractory metal oxides selected from one or more of alumina, zirconia, and ceria-zirconia supporting one or more precious group metal components.

25. A method of treating an exhaust gas stream comprising disposing the catalyst of claim 11 within the exhaust gas stream.

26. The method of claim 25, wherein the exhaust gas stream comprises hydrocarbons and carbon monoxide and the material is present on the substrate in an amount effective for the oxidation of the carbon monoxide and hydrocarbons.

27. The method of claim 25, wherein the exhaust gas stream comprises nitrogen oxides and the material is present on the substrate in an amount effective for the selective catalytic reduction of nitrogen oxides.

28. The method of claim 26, wherein the exhaust gas stream is generated from a diesel or gasoline engine.
